(19) United States
(12) Patent Application Publication
(10) Pub. No.: US 2017/0293625 A1
(43) Pub. Date: Oct. 12, 2017

(54) INTENT BASED CLUSTERING

(71) Applicant: Hewlett-Packard Development Company, L.P., Houston, TX (US)

(72) Inventors: Hila NACHLIELI, Haifa (IL); Renato KESHET, Haifa (IL); George FORMAN, Port Orchard, WA (US); Sagi SCHEIN, Haifa (IL)

(21) Appl. No.: 15/516,672

(22) PCT Filed: Oct. 2, 2014
(86) PCT No.: PCT/US2014/058837

§ 371 Date: Apr. 3, 2017

(51) Int. Cl. G06F 17/30; G06K 9/62

(52) U.S. Cl. CPC G06F 17/3071; G06F 17/30601; G06K 9/6215

(57) ABSTRACT

According to an example, intent based clustering may include generating a plurality of clusters based on an analysis of categories of features of data used to generate the clusters with respect to an order of each of the features by determining whether a number of samples of the data for a category of the categories meets a specified criterion.

### BACKGROUND

Clustering is typically the task of grouping a set of objects in such a way that objects in the same group (e.g., cluster) are more similar to each other than to those in other groups (e.g., clusters). In a typical scenario, a user provides a clustering application with a plurality of objects that are to be clustered. The clustering application typically generates clusters from the plurality of objects in an unsupervised manner, where the clusters may be of interest to the user.

### BRIEF DESCRIPTION OF DRAWINGS

Features of the present disclosure are illustrated by way of example and not limited in the following figure(s), in which like numerals indicate like elements, in which:

FIG. 1 illustrates an architecture of an intent based clustering apparatus, according to an example of the present disclosure;

FIG. 2 illustrates a flowchart for the intent based clustering apparatus of FIG. 1, according to an example of the present disclosure;

FIGS. 3A and 3B illustrate a cyber-security application of the intent based clustering apparatus, according to an example of the present disclosure;

FIGS. 4A-4D illustrate a voting-based application of the intent based clustering apparatus, according to an example of the present disclosure;

FIG. 5 illustrates a method for intent based clustering, according to an example of the present disclosure;

FIG. 6 illustrates further details of the method for intent based clustering, according to an example of the present disclosure; and

FIG. 7 illustrates a computer system, according to an example of the present disclosure.

### DETAILED DESCRIPTION

For simplicity and illustrative purposes, the present disclosure is described by referring mainly to examples. In the following description, numerous specific details are set forth in order to provide a thorough understanding of the present disclosure. It will be readily apparent however, that the present disclosure may be practiced without limitation to these specific details. In other instances, some methods and structures have not been described in detail so as not to unnecessarily obscure the present disclosure.

Throughout the present disclosure, the terms “a” and “an” are intended to denote at least one of a particular element. As used herein, the term “includes” means includes but not limited to, the term “including” means including but not limited to. The term “based on” means based at least in part on.

In a clustering application that generates clusters in an unsupervised manner, the resulting clusters may not be useful to a user. For example, a clustering application may generate clusters for documents related to boats based on color (e.g., red, blue, etc.) based on the prevalence of color-related terms in the documents. However, the generated clusters may be irrelevant to an area of interest (e.g., sunken boats, boats run aground, etc.) of the user. In this regard, according to examples, an intent based clustering apparatus and a method for intent based clustering are disclosed herein to generate clusters that align with a user's expectations of the way that data should be organized. Beyond clustering the data, the apparatus and method disclosed herein also provide an interactive process to provide for customization of clustering results to a user's particular needs and intentions. The clustering implemented by the apparatus and method disclosed herein further adds efficiency to the clustering process, thus reducing inefficiencies related to hardware utilization, and reduction in processing time related to generation of the clusters.

Generally, the apparatus and method disclosed herein may provide for clustering of categorical data that is based on, and/or complements, previously defined clusters. Categorical data may be described as data with features whose values may be grouped based on categories. A category may represent a value of a feature of the categorical data. A feature may include a plurality of categories. For example, in the area of cyber-security, data may be grouped by features related to operating system, Internet Protocol (IP) address, packet size, etc. For the apparatus and method disclosed herein, categorical data may be clustered (e.g., to generate new clusters) so as to take into account already defined clusters (e.g., initial clusters). For the apparatus and method disclosed herein, the aspect of complementing previously defined clusters may provide, for example, determination of new and emerging problems that are being reported about a company's products. For example, a data analyst or domain expert may determine new and emerging problems with respect to a company's products.

For the apparatus and method disclosed herein, categorical data may be clustered based on a pre-defined order of the data. The pre-defined order may be based on Kullback-Leibler (KL) distances (i.e., mutual information) between histograms of each feature in clustered data versus non-clustered data, user feedback, feature entropy, a number of categories in a feature, and/or random numbers.

For the apparatus and method disclosed herein, thresholds may be pre-defined constants, or a function of several parameters including the number of features in a cluster definition, the maximal distance between items in a cluster, the number of clusters that are already defined, the number of items being currently processed, and/or the number of items in each of the other clusters divided (or not) by the number of items that are being processed since the other clusters were determined.

According to an example, the apparatus disclosed herein may include a processor, and a memory storing machine readable instructions that when executed by the processor cause the processor to generate a plurality of initial clusters from objects, where the objects include features (e.g., attributes) that include categories. The machine readable instructions may further cause the processor to receive user feedback related to the initial clusters, order the features of the objects as a function of, for example, a histogram of values of each of the features based on the user feedback (and/or feature entropy, and/or a number of categories in the feature, and/or random numbers), and determine whether a number of samples of the objects for a category of the categories meets a specified criterion (e.g., exceeding a specified threshold). The specified threshold may be a function of, for example, the number of features in a cluster definition and/or the maximal distance between the items in a cluster. The machine readable instructions may further cause the processor to generate a plurality of new clusters based on an analysis of the categories of each of the features with respect to the order based on the determination of whether the number of samples of the objects for the category of the categories meets the specified criterion.

According to an example, the machine readable instructions to generate a plurality of initial clusters from objects may further include ordering the features of the objects based on an entropy of each of the features. According to an example, the machine readable instructions to generate a plurality of initial clusters from objects may further include recursively analyzing each of the categories of each of the features in order of increasing entropy of each of the features based on the determination of whether the number of samples of the objects for each of the categories of each of the features meets the specified criterion of exceeding a threshold. According to an example, the machine readable instructions to order the features of the objects as a function of a histogram of values of each of the features based on the user feedback may further include determining histograms of values obtained by each of the features in clustered objects and in non-clustered objects, and determining KL distances between the histograms.

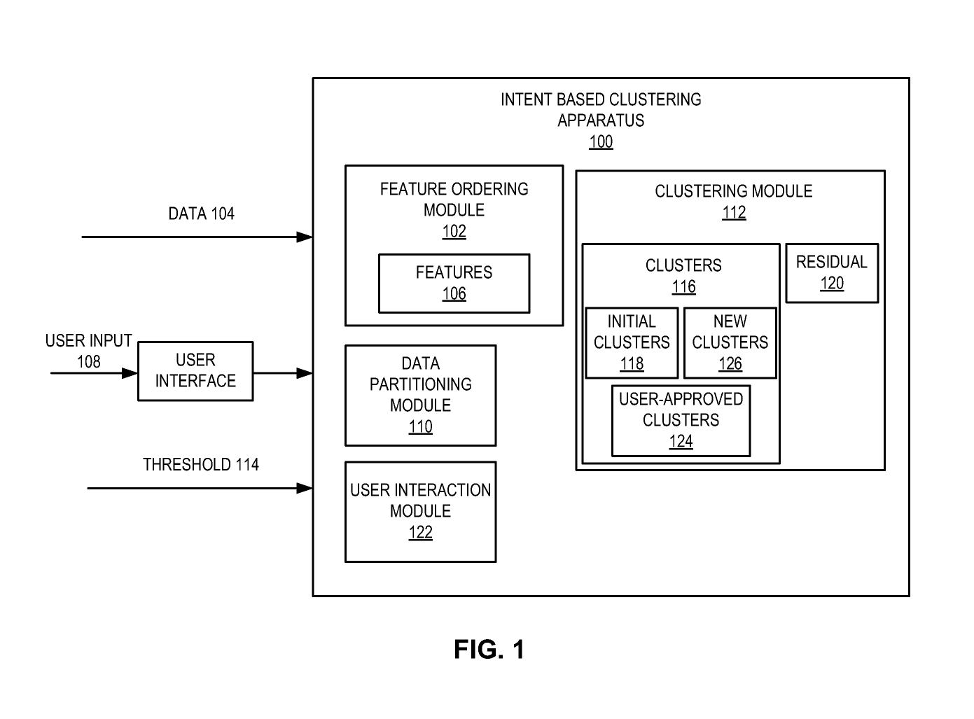

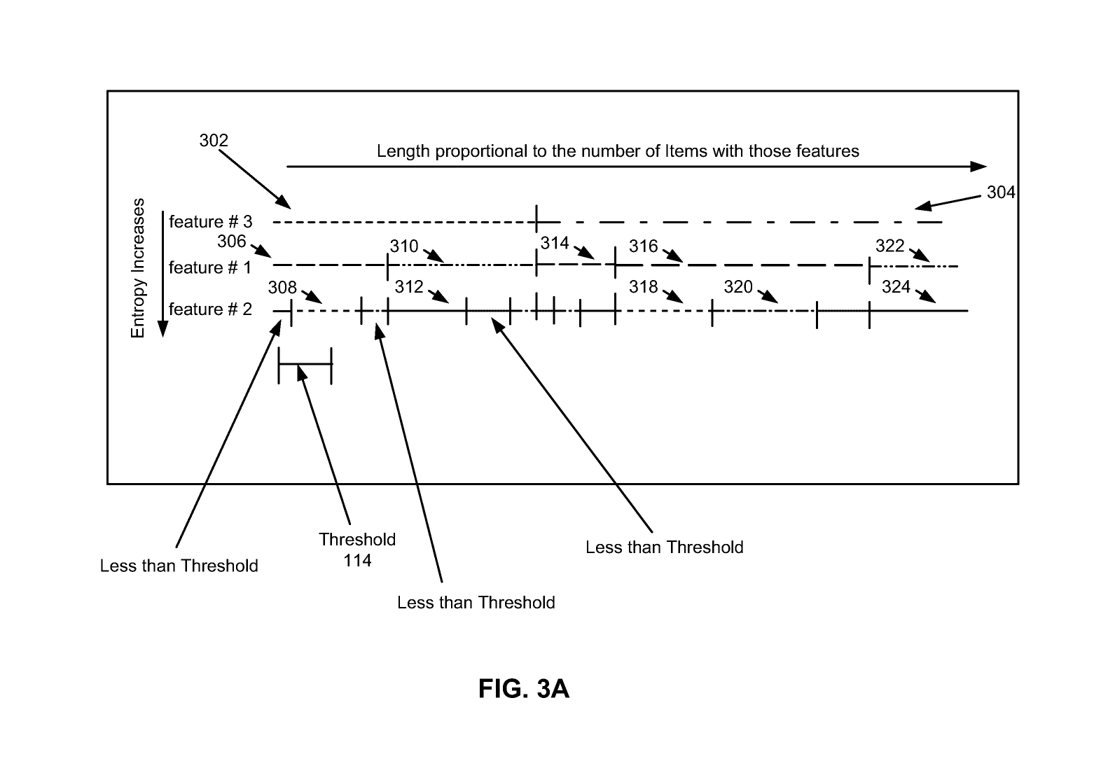

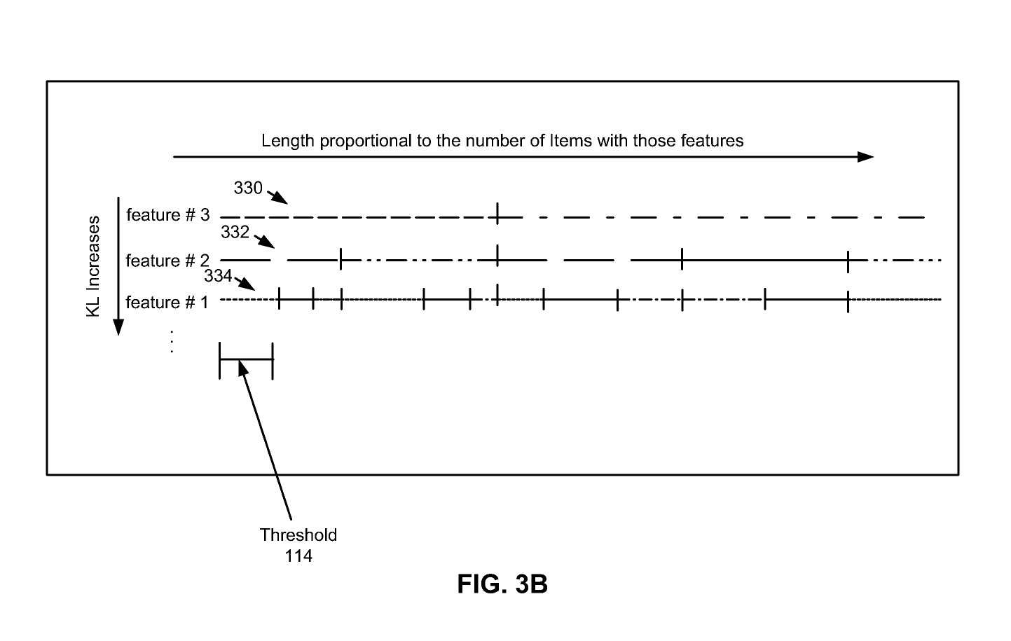

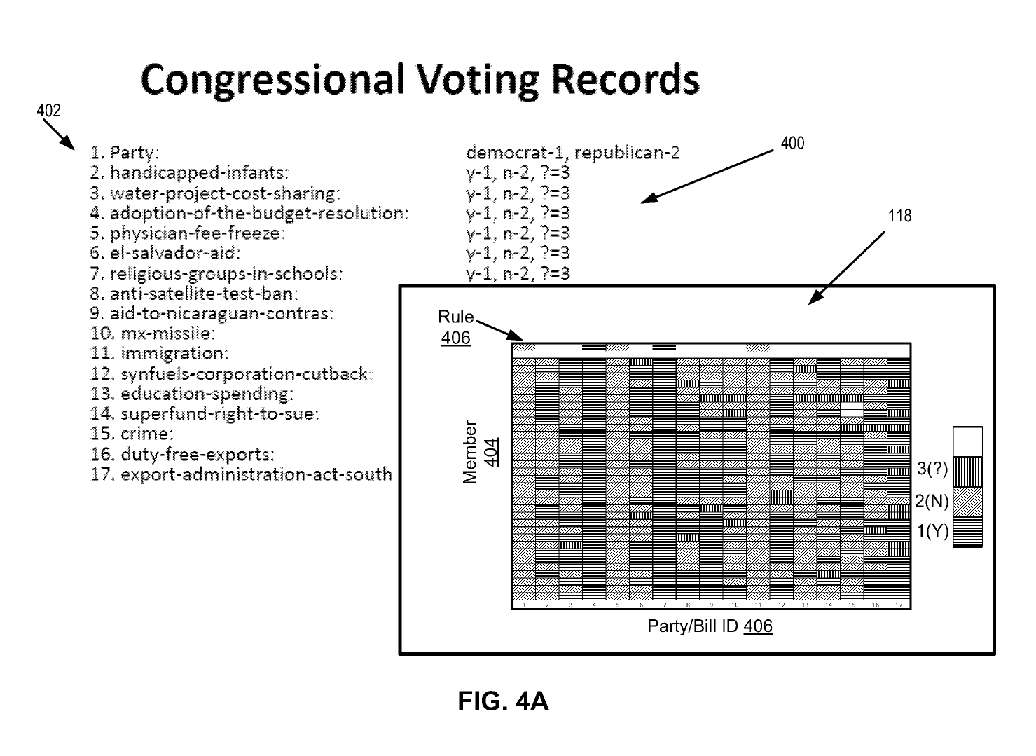

FIG. 1 illustrates an architecture of an intent based clustering apparatus (hereinafter also referred to as “apparatus 100”), according to an example of the present disclosure. Referring to FIG. 1, the apparatus 100 is depicted as including a feature ordering module 102 to receive data 104 that is to be clustered. The data 104 may be categorical data which may include data with features whose values may be categorized in particular categories without any specific order to the values of the data. For example, referring to FIG. 3A, the data 104 may be related to cyber-security data which may include feature #1 which may be packet sizes, feature #2 which may be IP addresses, and feature #3 which may be particular operating systems. For the data 104, referring to the example of FIG. 3A, a case (or record) may be represented in FIG. 3A by a predetermined width in a direction orthogonal to the entropy direction, and include each of the features (e.g., features #1 to #3). For the block of data illustrated in FIG. 3A (i.e., all of the data shown in FIG. 3A), the features may be ordered in order of increasing entropy from feature #3 to feature #1 to feature #2, and the relevant data values for each feature may be grouped (e.g., by using a group-by operation) in the orthogonal direction relative to the entropy direction.

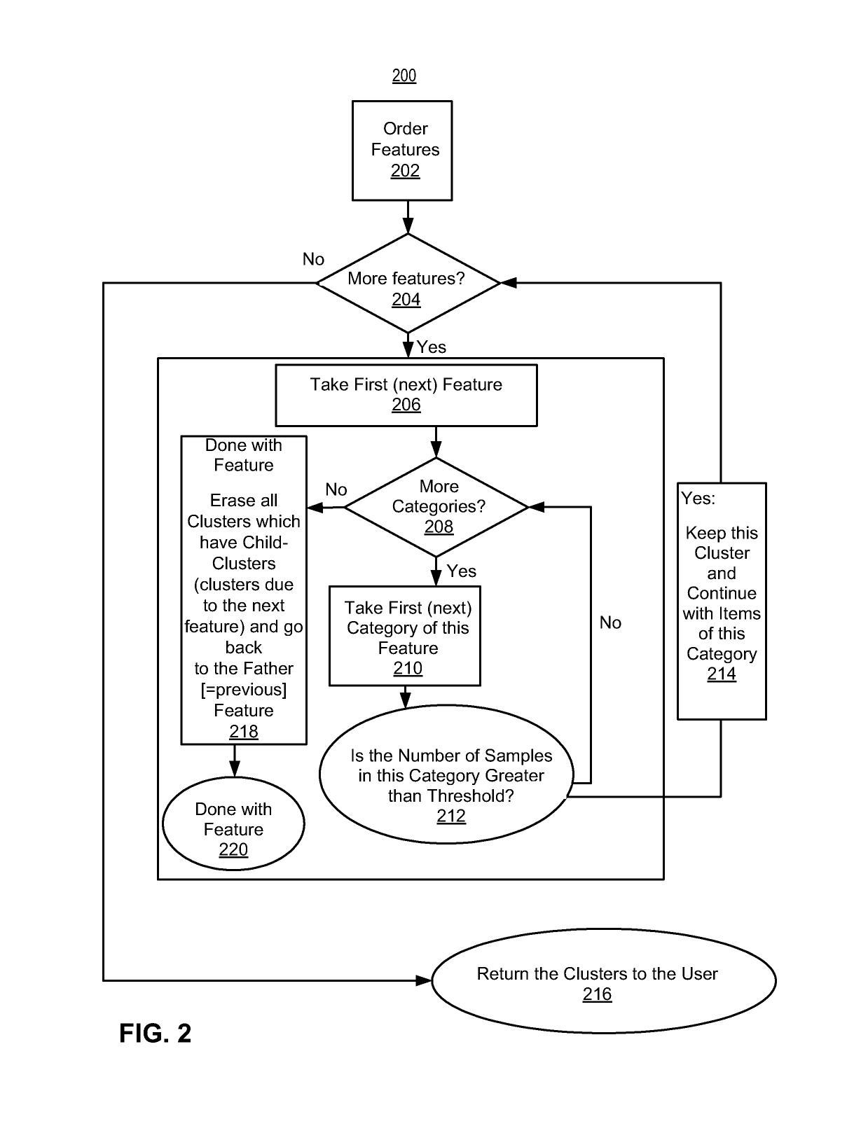

FIG. 2 illustrates a flowchart 200 for the intent based clustering apparatus of FIG. 1, according to an example of the present disclosure. Referring to FIG. 1 and block 202 of FIG. 2, the feature ordering module 102 may order features 106 of the data 104 by combining user feedback, feature entropy, a number of categories in the feature, and/or random numbers, and if there are user approved clusters, then for each of the features 106, a histogram of the values that each feature obtains in clustered data and in non-clustered data may be determined, and the Kullback-Leibler (KL) distance between the two histograms (i.e., for each feature, the histograms for the clustered data and in the non-clustered data) may be determined. For the example of FIG. 3A, features #1-#3 may be ordered with respect to feature entropy. The feature entropy may be determined as a function of the sum over all of the categories as follows:

Feature Entropy=−Sum over all of the categories i of (pᵢ*(log(pᵢ))) Equation (1)

For Equation (1), ρᵢ represents the probability of a data value being in a particular category i. Generally, features may include a higher feature entropy based on a relatively lower number of categories and a relatively similar amount (i.e., balanced) of the values for the categories. For the example of FIG. 3A, feature #3, which includes a relatively lower number of categories and a relatively similar amount of the values for the categories, includes a lower feature entropy compared to features #1 and #2.

With respect to the feature ordering module 102, the user feedback may be either direct or indirect. For example, direct feedback may include manipulation of a cluster by a user via user input 108. Indirect feedback may include dragging items from one cluster to another.

A data partitioning module 110 is to take a block of the data 104 that fits into memory, and apply a recursive process as described with reference to the flowchart 200 of FIG. 2 to cluster the data 104. For the example of FIG. 3A, the block of the data 104 may represent all the values for features #1-#3 as shown.

In order to cluster the data 104, a clustering module 112 is to utilize the ordered features to cluster the data 104. Starting with the first feature, the clustering module 112 may determine whether there are additional features that may be used to cluster the data 104. For the flowchart 200 of FIG. 2, at block 204, the clustering module 112 may determine whether there are additional features that may be used to cluster the data 104.

In response to a determination that there are additional features that may be used to cluster the data 104 (e.g., since there are greater than zero features, the output to block 204 is yes), the clustering module 112 may begin with the first (i.e., lowest entropy) feature (or take the next feature after the first feature has been analyzed) to cluster the data 104 for this first feature by all possible values of this feature. For example, referring to FIG. 2, at block 206, the clustering module 112 may begin with the first feature to cluster the data 104 by all possible values of this feature. For the example of FIG. 3A, the clustering module 112 may begin with feature #3 to cluster the data for all possible values of feature #3. For the example of FIG. 3A, the data for feature #3 for the block selected by the data partitioning module 110 may be grouped into categories 302 and 304 that respectively represent operating system-A and operating system-B.

At block 208, the clustering module 112 may determine whether there are additional categories for the feature evaluated at block 206.

In response to a determination that there are additional categories for the feature evaluated at block 206 (i.e., since there are greater than zero categories, the output to block 208 is yes), at block 210, the clustering module 112 may begin with the first category of the first feature. For the example of FIG. 3A, at block 210, the clustering module 112 may begin with the category 302 of feature #3.

At block 212, the clustering module 112 may determine whether a number of samples in the first category (e.g., category 302 for the example of FIG. 3A) is greater than a threshold 114. As described herein, threshold 114 may be a pre-defined constant, a portion of the number of samples being processed, and/or a function of the number of identical features that are identified in a cluster.

In response to a determination that a number of samples in the first category (e.g., category 302 for the example of FIG. 3A) is greater than the threshold 114, at block 214, the clustering module 112 may retain this cluster (i.e., the cluster defined by the category 302 for the example of FIG. 3A), and continue analysis of other features with items of this category. In this regard, with respect to the continued analysis of other features with items of this category, reverting back to block 204, the clustering module 112 may determine that there are additional features (e.g., feature #1 and further feature #2 for the example of FIG. 3A) that may be used to cluster the data 104.

At block 206, in response to a determination that there are additional features that may be used to cluster the data 104, the clustering module 112 may continue with the next feature (e.g., feature #1 for the example of FIG. 3A) after the previous feature (e.g., feature #3 for the example of FIG. 3A) has been analyzed, and for each of the values of the previous feature (e.g., the values of feature #3 for the example of FIG. 3A), the clustering module 112 may proceed to the next feature (e.g., feature #1 for the example of FIG. 3A) and sub-cluster the data by its values. Generally, the clustering module 112 may continue with the sub-clustering of the data by its values until the number of samples in the category being analyzed is less than the threshold 114, in which case the previous larger cluster is retained for clustering purposes. However, if the number of samples in the category being analyzed is greater than the threshold 114, the cluster based on the category being analyzed is retained.

In response to a determination at block 208 that there are more categories for the next feature (e.g., feature #1 for the example of FIG. 3A) after the previous feature (e.g., feature #3 for the example of FIG. 3A), at block 210 the clustering module 112 may begin with the first category (e.g., category 306) for the next feature (e.g., feature #1 for the example of FIG. 3A).

At block 212, the clustering module 112 may determine whether a number of samples in the first category (e.g., category 306 for the example of FIG. 3A) is greater than the threshold 114. For the example of FIG. 3A, since the number of samples for category 306 is greater than the threshold 114, at block 214, the cluster defined by categories 302 and 306 may be retained.

In this manner, further categories for the next feature (e.g., feature #1, and then feature #2 for the example of FIG. 3A) after the previous feature (e.g., feature #3, and then feature #1 for the example of FIG. 3A) may be processed in direction of increasing order (e.g., increasing entropy) to generate clusters 116 including initial clusters 118 using blocks 204, 206, 208, 210, 212, and 214 of FIG. 2. For the example of FIG. 3A, since the number of samples for the first category for feature #2 (i.e., category adjacent category 308) is less than the threshold 114, processing may revert to category 306 of feature #1, and further to category 308 for feature #2 (where the number of samples for the category 308 for feature #2 is greater than the threshold 114). Thus, for the example of FIG. 3A, the first cluster (i.e., cluster #1) may be defined to include categories 302, 306, and 308. Further, in response to a determination at block 208 that there are more categories (e.g., category 304 for the example of FIG. 3A) for the first feature (e.g., feature #3 for the example of FIG. 3A), at block 210 the clustering module 112 may take the first corresponding category (e.g., category 314) for the next feature (e.g., feature #1 for the example of FIG. 3A), and further evaluate blocks 212, etc. For the example of FIG. 3A, with respect to category 314, since the corresponding categories for feature #2 each include less samples than the threshold 114, this results in a cluster that includes category 304 from feature #3 and category 314 from feature #1. The initial clusters using blocks 204, 206, 208, 210, 212, and 214 of FIG. 2 may be returned to a user at block 216 after all features have been evaluated.

With respect to features #1-#3 for the example of FIG. 3A, the initial clusters that are generated using blocks 204, 206, 208, 210, 212, and 214 of FIG. 2 include cluster #1 that includes categories 302, 306, and 308, cluster #2 that includes categories 302, 310, and 312, cluster #3 that includes categories 304 and 314, cluster #4 that includes categories 304, 316, and 318, cluster #5 that includes categories 304, 316, and 320, and cluster #6 that includes categories 304, 322, and 324. The initial clusters may represent clusters that are presented to the user without user input (or with user input if the user has previously provided user input as to the preference for certain clusters). For the example of FIG. 3A, the initial clusters #1 to #6 may represent clusters that are presented to the user without user input, and are based on feature entropy.

At block 218, in response to a determination that there are no additional categories (e.g., no additional categories for feature #3 for the example of FIG. 3A), the clustering module 112 may erase all clusters that have child-clusters (i.e., clusters due to the next feature), and revert back to the previous feature.

With the initial clusters 118 in a block of the data 104 being determined, the clustering module 112 may mark all data items that fit the initial clusters 118 as clustered, and all of the data items that do not fit the initial clusters 118 as residual (i.e., for adding the data items that do not fit the clusters to a residual 120). For the example of FIG. 3A, with respect to feature #2, the clustering module 112 may mark all data items (e.g., the data items for categories 308, 312, 318, 320, and 324) that fit the initial clusters 118 as clustered, and all of the data items (e.g., the remaining data items) that do not fit the initial clusters 118 as residual (e.g., for adding to the residual 120).

In certain cases, an “ignore feature” parameter g may be defined. This parameter may be used when feature weights entered by a user result in a feature order that yields clusters which are not sufficiently deep (i.e., clusters that do not include sufficient features). In such cases, if there is no new cluster for this feature, but g>0, block 220 may be bypassed, and processing may instead proceed to block 204. The cluster and the rule that defines the feature may remain unchanged, and the unhelpful feature may be ignored. In this case, the ignore feature parameter g may be decreased by 1.

The data partitioning module 110 may take a next block of the data 104, and the clustering module 112 may assign the data items to the known clusters (e.g., the clusters #1 to #6 for the example of FIG. 3A). The data items that match no clusters may be added to the residual 120.

In this manner, the data partitioning module 110, and the clustering module 112 may continue to cluster blocks of data and add to the residual 120, until the residual 120 is larger than a specified size. Once the residual 120 is larger than a specified size, the data for the residual 120 may be similarly clustered as described with reference to blocks 202-220. The order of processing may remain unchanged (e.g., copied from the previous order). However, the order of processing may also be changed, for example, because the block content is different and the entropies are to be re-determined, or if there are no new clusters in the last few blocks, the cluster propositions may need to be refreshed. For example, once the number of samples of the residual 120 (e.g., N(residual)) is larger than a specified size (e.g., N(block)*constant, where block is the size of a block of data used by the data partitioning module 110, and constant is a specified number), the data for the residual 120 may be similarly clustered as described with reference to blocks 202-220. In this regard, the feature order (e.g., based on feature entropy) with respect to block 202 may be re-determined or used as previously determined. For the example of FIG. 3A, the residual 120 may include all of the data items (e.g., the remaining data items) that do not fit the clusters #1 to #6 based on the initial processing by the data partitioning module 110, and the clustering module 112. However, after initial processing by the data partitioning module 110, and the clustering module 112, the data items of the residual 120 may be clustered prior to being analyzed by the clustering module 112. The clustering with respect to the residual 120 may be continued until all of the data is processed.

Once the initial clusters 118 are generated, a user interaction module 122 is to receive results from user interaction (i.e., the user input 108) with the proposed initial clusters 118. The user interaction module 122 may also receive input from user interaction, prior to generation of the initial clusters 118, or during generation of the initial clusters 118 for each block of the data 104. For example, a user may utilize the user interaction module 122 to modify alignment of the proposed clusters to the user's needs. For example, a user may obtain a cluster description, obtain items (e.g., data) from a cluster, rename a cluster, set an action with respect to a cluster (e.g., alert, don't show), delete a feature from cluster definition, merge clusters, divide clusters, define a new cluster from features, create a new cluster based on data from a cluster, submit a cluster of items to classify, assign items to a relevant cluster, delete a cluster, etc. Each of these interactions by a user may change the clustering version (e.g., from the initial cluster version, to a modified cluster version). The clusters that are modified based on the user interaction may be designated as user-approved clusters 124. For the example of FIG. 3A, a user may delete, for example, feature #2, or another feature not shown in FIG. 3A, from the definition of one of the clusters. Alternatively or additionally, a user may divide one of the clusters #1 to #6 that the user considers to be too large.

The clusters that are modified by a user may be used as input of block 202, and lead to a different KL score for each feature. For example, referring to block 202, the feature ordering module 102 may order the features 106 (e.g., the features #1 to #3 for the example of FIG. 3A) of the data 104 by combining user feedback (i.e., via the user input 108), feature entropy, and for each of the features of the user-approved clusters 124, a histogram of the values that each feature obtains in clustered data and in non-clustered data may be determined, and the KL distance between the two histograms (i.e., for each feature, the histograms for the clustered data and in the non-clustered data of the residual 120) may be determined. The KL distance, which represents mutual information, may be determined by the following function:

$${D}_{KL} ( P \vert \vert Q ) = {\sum }_{bins i} ln ( \frac{{P}_{i}}{{Q}_{i}} ) {P}_{i} \qquad Equation ( 2 )$$

For Equation (2), P represents a histogram of the values that a feature obtains in clustered data, and Q represents a histogram of the values that a feature obtains in the residual 120. With respect to Equation (2), user manipulation of a cluster may change the cluster, and hence that samples that are in the cluster (i.e., the samples that represent the cluster). Thus, user manipulation of a cluster may change the histogram P, and further, Q histograms may change with each block of data. With respect to user manipulation (e.g., dividing a cluster), entropy calculation, and KL distance calculation, a function may be defined to combine several numbers for each feature (e.g., several “vectors”) into one number for each feature (e.g., one “vector”), and then order the resulting number. The features may be ordered as a function of user weights and KL distance, and if two features have the same number, by user weight, then by KL distance, and then by entropy. The different KL score for each feature may result in a different order of features in which the recursive clustering operates. This results in a closer fit of proposed new clusters 126 to the needs of the user.

For the example of FIG. 3A, referring to FIG. 3B, assuming a user approves some of the clusters, the resulting features #1 to #3 include a different distribution of data for the various categories, and thus result in a different set of new clusters 126 that provide a closer fit to the needs of the user. The order of the features may also change compared to FIG. 3A (e.g., from feature #3 to feature #1 to feature #2 for FIG. 3A, to feature #3 to feature #2 to feature #1 for FIG. 3B). For example, the first cluster (i.e., cluster #1) for FIG. 3B includes categories 330, 332, and 334. Compared to FIG. 3A, for FIG. 3B, the category adjacent to category 308 for the initial clusters 118 include a number of samples that that are less than the threshold 114, whereas, for FIG. 3B, the category 334 includes a number of samples that are greater than the threshold 114. Thus, cluster #1 for the initial clusters 118 differs from cluster #1 for the new clusters 126.

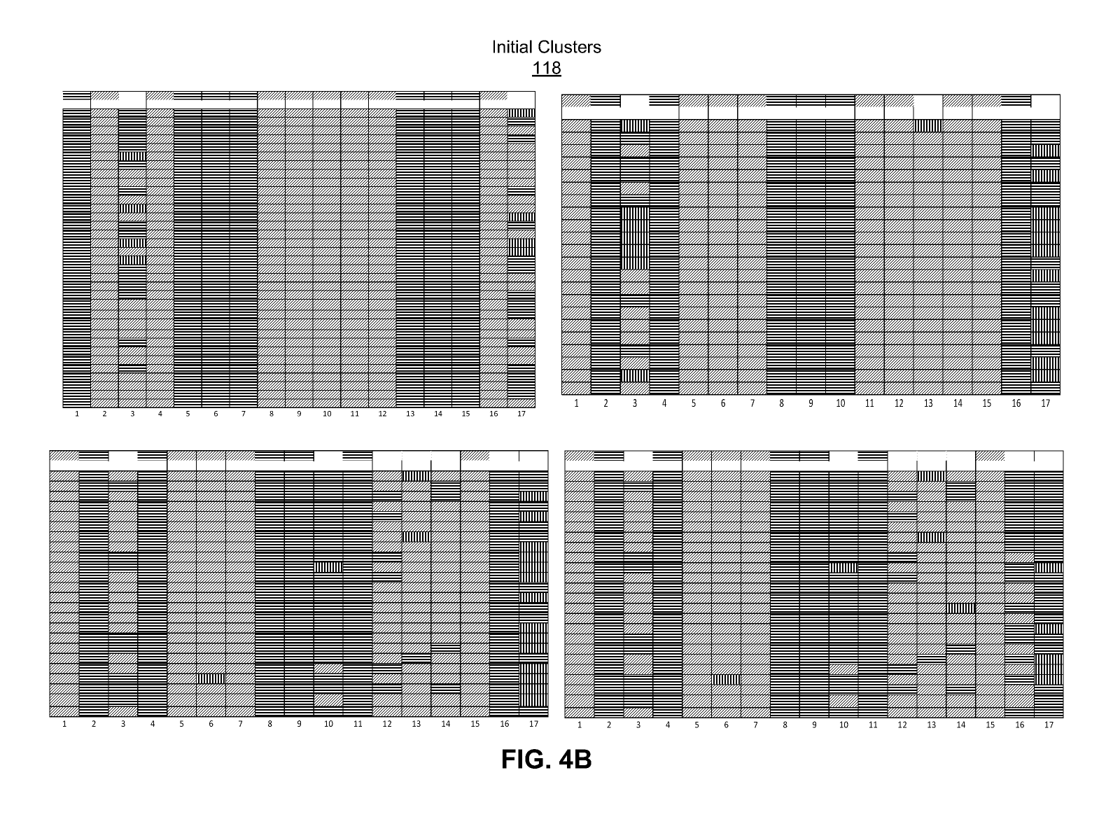

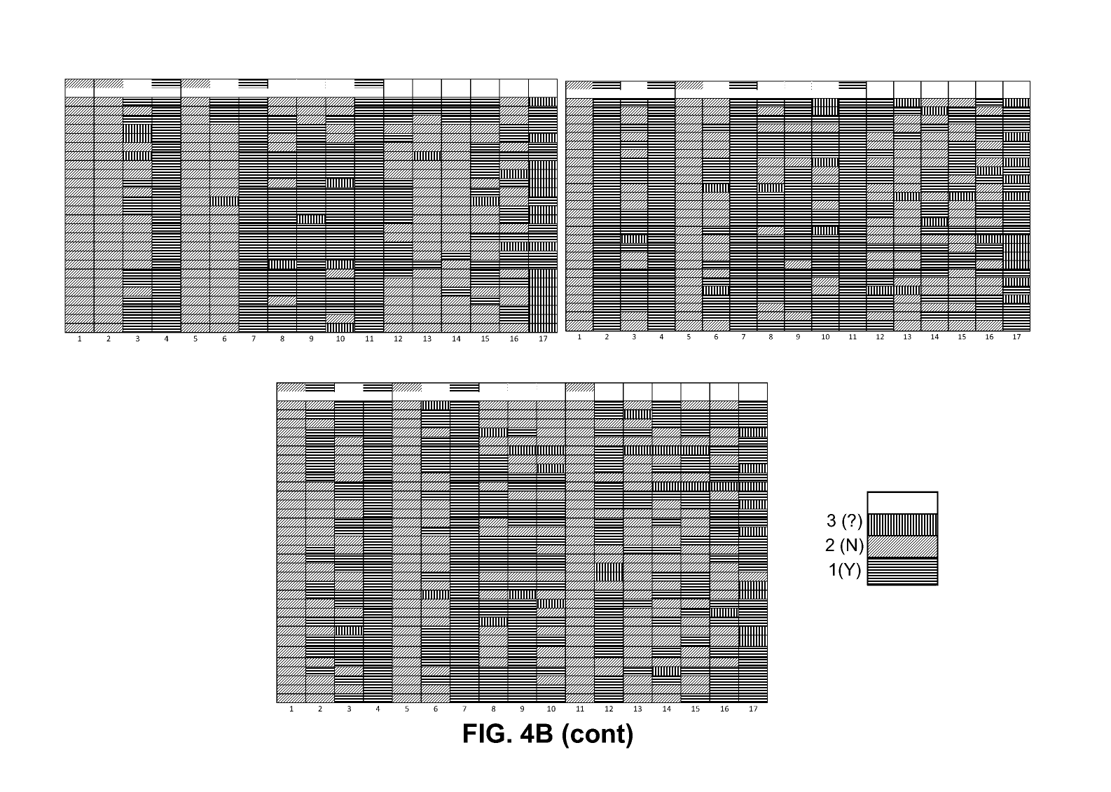

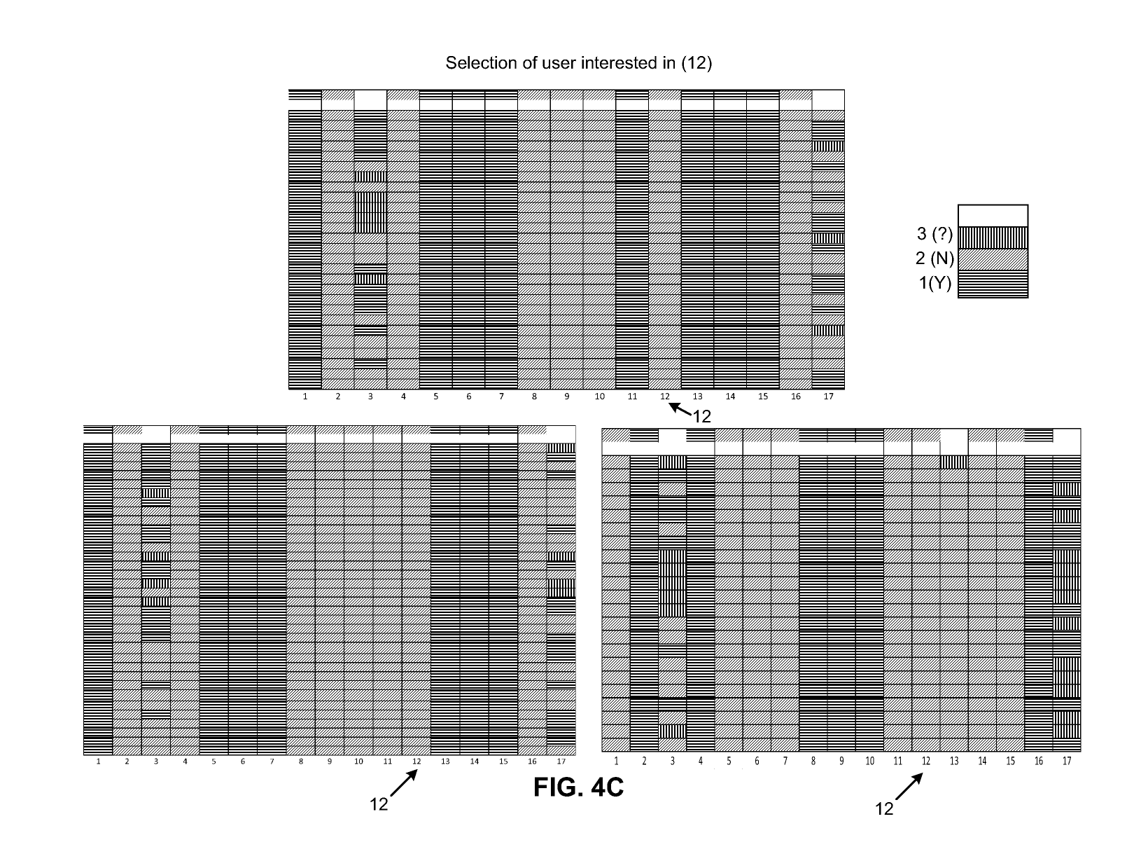

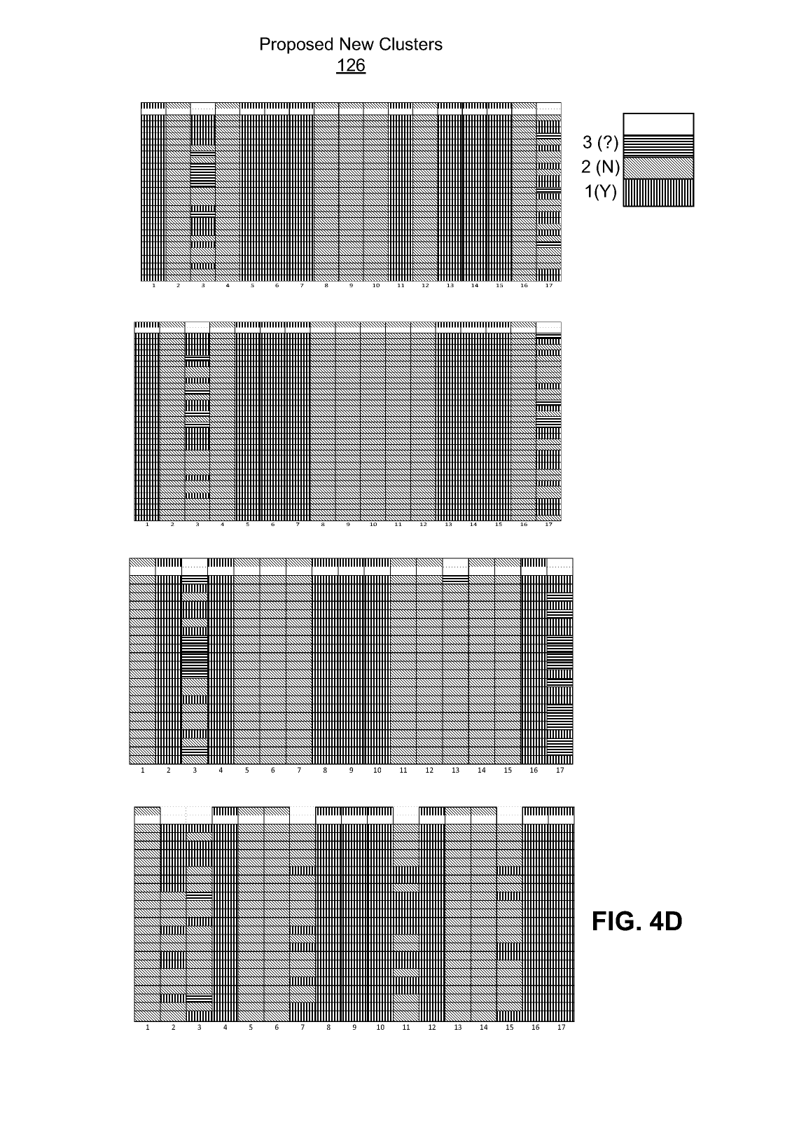

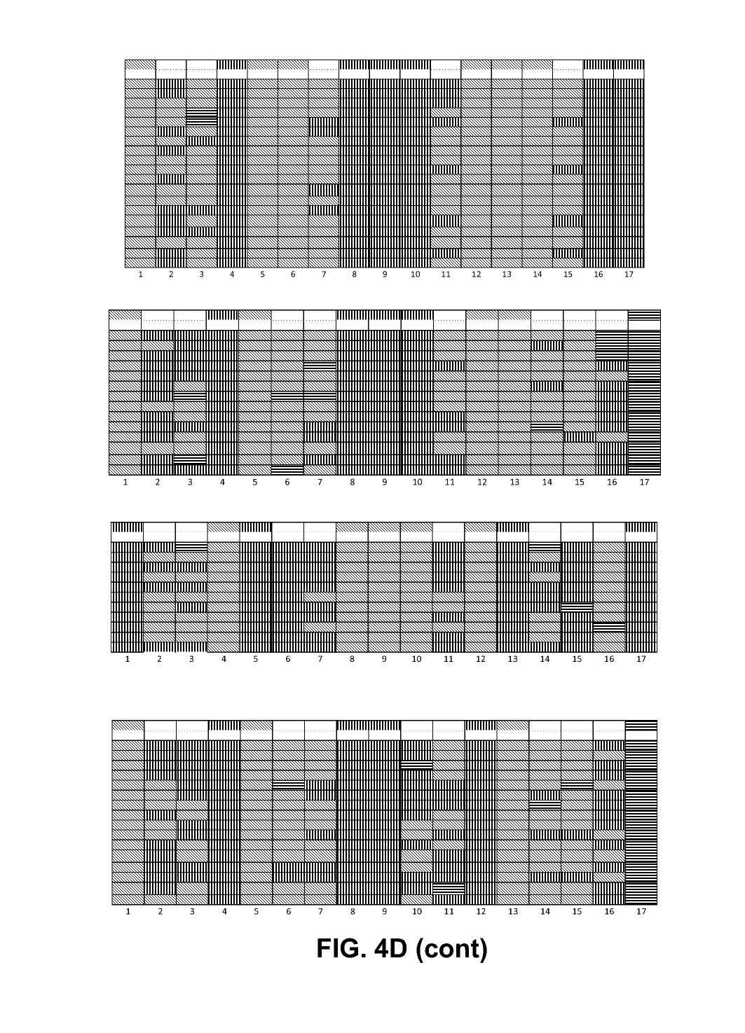

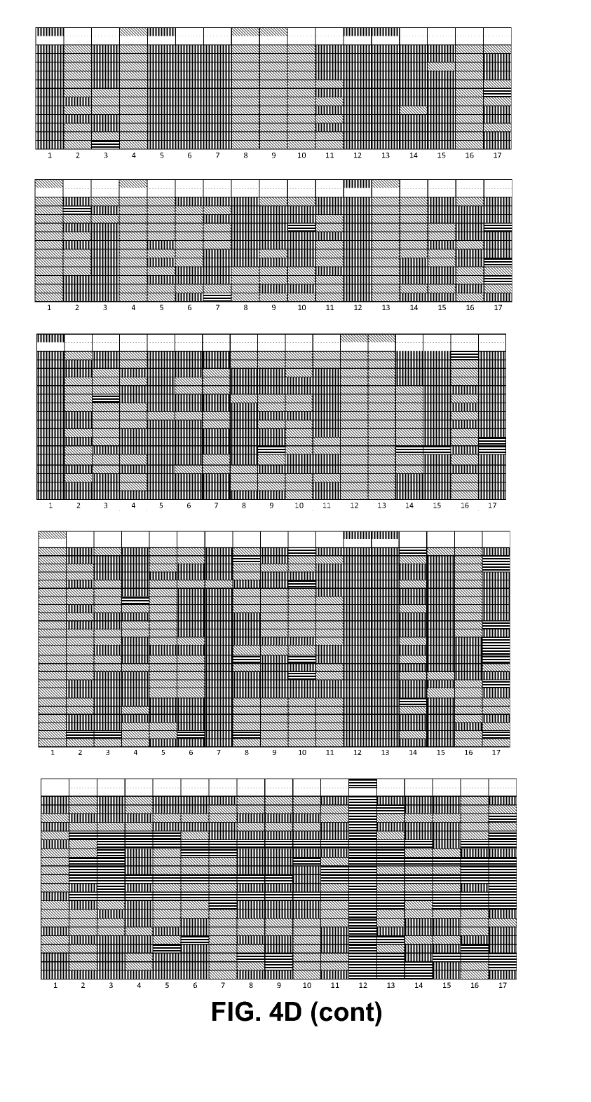

FIGS. 4A-4D illustrate a voting-based application of the intent based clustering apparatus, according to an example of the present disclosure. For the example of FIGS. 4A-4D, data 400 that is used to generate initial clusters is shown in FIG. 4A. The data 400 may include party/bill identification 402 shown as columns 1-17 in the initial clusters 118 (one initial cluster 118 shown in FIG. 4A), and voting members shown at 404. For illustrative purposes, a subset of the voting members 404 is shown in FIGS. 4A-4D (e.g., approximately 30 voting members 404 shown in the initial cluster 118 for FIG. 4A). A rule 406 related to the initial cluster 118 shows content or how a vote related to a particular party/bill identification is to be made (e.g., all democratic, all republican, all yes (dark gray), all no (black), all unknown (light gray), no restriction (white)). The first column of the initial clusters 118 represents the party of each of the voting members 404, and the remaining columns 2-17 represent a vote by each of the voting members 404 (e.g., yes (1), no (2), unknown (3)).

Referring to FIG. 4B, the clustering module 112 may utilize the ordered features related to the party/bill identification 402 to cluster the data 400, and to generate a plurality of the initial clusters 118. The initial clusters 118 may be of different sizes, but are shown as including a uniform size for illustrative purposes. Referring to FIG. 4C, assuming that the user uses the user interaction module 122 to select the clusters that are of interest, for example, if the user is interested in feature number 12 related to synfuels-corporation-cutback (i.e., column 12 of the initial clusters 118 (see also FIG. 4A)), the user may select the clusters where feature 12 is uniform. The clusters that are selected by the user may be designated as approved clusters. Each cluster may include a different related histogram, and thus a different KL score. Thus, the modification (e.g., selection) by the user may be used as input of block 202 of FIG. 2, and lead to a different KL score for each feature. Referring to FIG. 4D, the different KL score for each feature may result in a different order of features in which the recursive clustering operates. This results in a closer fit of the proposed new clusters 126 to the needs of the user. As with the initial clusters 118, the new clusters 126 may be of different sizes, but are shown as including a uniform size for illustrative purposes.

The modules and other elements of the apparatus 100 may be machine readable instructions stored on a non-transitory computer readable medium. In this regard, the apparatus 100 may include or be a non-transitory computer readable medium. In addition, or alternatively, the modules and other elements of the apparatus 100 may be hardware or a combination of machine readable instructions and hardware.

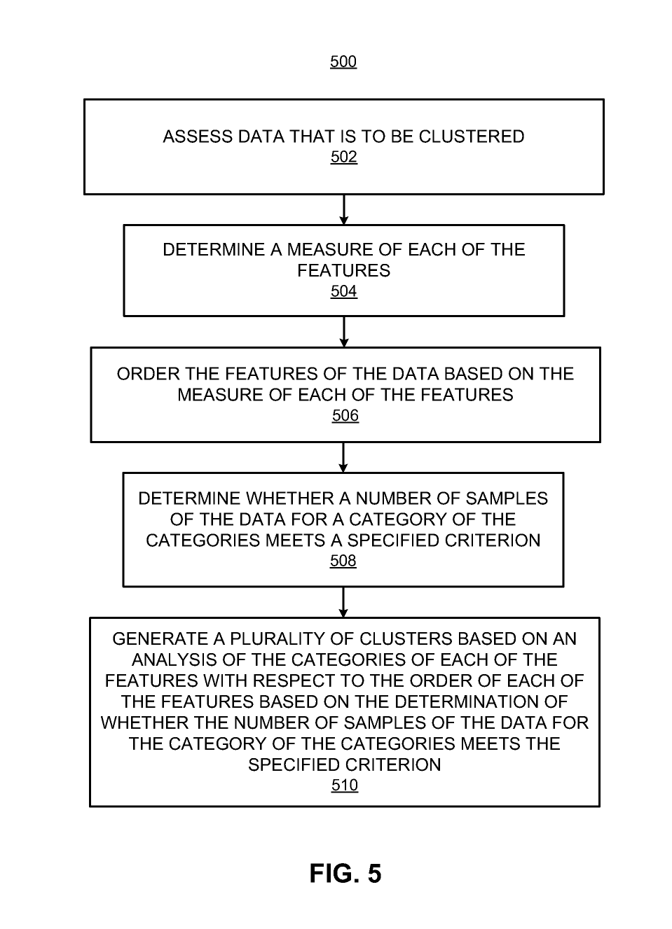

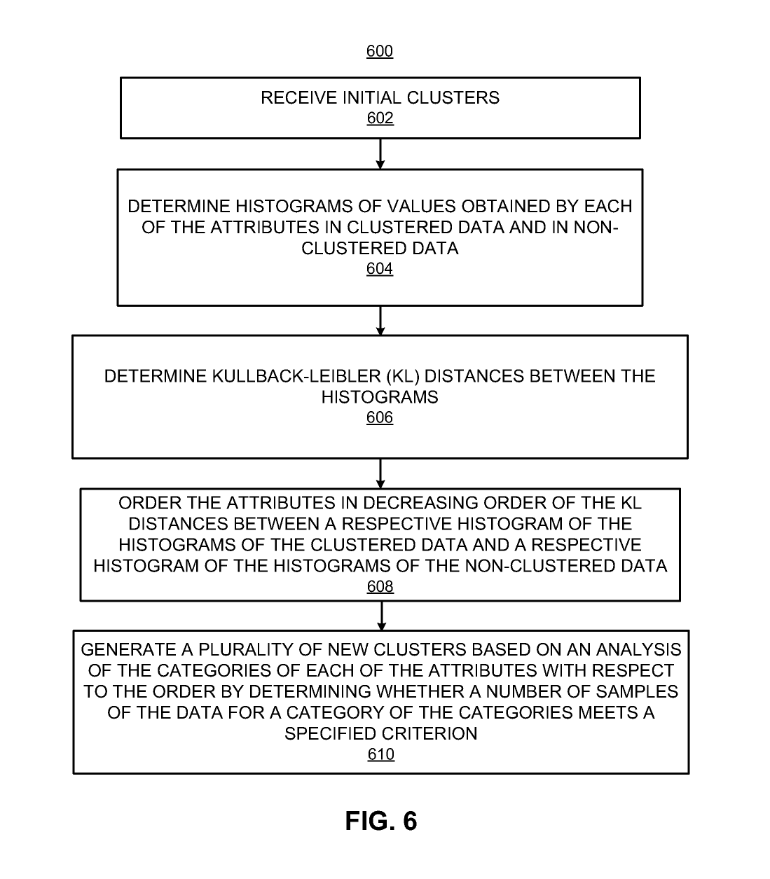

FIGS. 5 and 6 respectively illustrate flowcharts of methods 500 and 600 for intent based clustering, corresponding to the example of the intent based clustering apparatus 100 whose construction is described in detail above. The methods 500 and 600 may be implemented on the intent based clustering apparatus 100 with reference to FIGS. 1 and 2 by way of example and not limitation. The methods 500 and 600 may be practiced in other apparatus.

Referring to FIG. 5, for the method 500, at block 502, the method may include assessing data that is to be clustered, where the data may include features that include categories.

At block 504, the method may include determining a measure of each of the features. For example, as described herein with reference to FIGS. 1-4D, the feature ordering module 102 may determine a measure of each of the features 106. A measure may be described as a parameter such as, for example, a KL distance (i.e., mutual information) between histograms of a feature in clustered data versus non-clustered data, user feedback, feature entropy, a number of categories in a feature, and/or random numbers, etc.

At block 506, the method may include ordering the features of the data based on the measure of each of the features. For example, as described herein with reference to FIGS. 1-4D, the feature ordering module 102 may order the features 106 of the data 104 based on the measure of each of the features 106.

At block 508, the method may include determining whether a number of samples of the data for a category of the categories meets a specified criterion. For example, as described herein with reference to FIGS. 1-4D, the clustering module 112 may determine whether a number of samples of the data 104 for a category of the categories meets a specified criterion. For example, referring to FIG. 2, at block 212, the clustering module 112 may determine whether a number of samples in the first category (e.g., category 302 for the example of FIG. 3A) is greater than a threshold 114. As described herein, threshold 114 may be a pre-defined constant, a portion of the number of samples being processed, and/or a function of the number of identical features that are identified in a cluster.

At block 510, the method may include generating a plurality of clusters based on an analysis of the categories of each of the features with respect to the order of each of the features based on the determination of whether the number of samples of the data for the category of the categories meets the specified criterion. For example, as described herein with reference to FIGS. 1-4D, the clustering module 112 may generate a plurality of clusters (e.g., the initial clusters 118) based on an analysis of the categories of each of the features with respect to the order of each of the features based on the determination of whether the number of samples of the data 104 for the category of the categories meets the specified criterion. For example, referring to FIGS. 2 and 3A, the initial clusters that are generated using blocks 204, 206, 208, 210, 212, and 214 of FIG. 2 include cluster #1 that includes categories 302, 306, and 308, cluster #2 that includes categories 302, 310, and 312, cluster #3 that includes categories 304 and 314, cluster #4 that includes categories 304, 316, and 318, cluster #5 that includes categories 304, 316, and 320, and cluster #6 that includes categories 304, 322, and 324.

According to an example, for the method 500, generating a plurality of clusters based on an analysis of the categories of each of the features with respect to the order of each of the features based on the determination of whether the number of samples of the data for the category of the categories meets the specified criterion may further include recursively analyzing each of the categories of each of the features in order of increasing entropy of each of the features based on the determination of whether the number of samples of the data for each of the categories of each of the features meets the specified criterion of exceeding a threshold.

According to an example, for the method 500, the plurality of clusters may be designated as initial clusters, the method may further include receiving user feedback related to the initial clusters, and generating a plurality of new clusters based on the user feedback.

According to an example, for the method 500, generating a plurality of new clusters based on the user feedback may further include ordering the features as a function of histograms of values of each of the features.

According to an example, for the method 500, generating a plurality of new clusters based on the user feedback may further include determining histograms of values obtained by each of the features in clustered data and in non-clustered data, determining KL distances between the histograms, ordering the features based on the KL distances between each of the features, and generating the plurality of new clusters based on an analysis of the categories of each of the features with respect to the order based on KL distances based on the determination of whether the number of samples of the data for the category of the categories meets the specified criterion.

According to an example, the method 500 may further include processing blocks of the data to generate the plurality of new clusters, and combining respective new clusters of the plurality of new clusters that are generated based on the processing of the blocks of the data.

Referring to FIG. 6, for the method 600, at block 602, the method may include receiving initial clusters, where the initial clusters may be based on data that includes attributes that include categories. For example, as described herein with reference to FIGS. 1-4D, the clustering module 112 may receive the initial clusters 118, where the initial clusters may be based on data 104 that includes attributes that include categories (e.g., see FIG. 3A, where the attributes may be ordered similarly as the features and the categories are as described herein with reference to FIG. 3A).

At block 604, the method may include determining histograms of values obtained by each of the attributes in clustered data and in non-clustered data. For example, as described herein with reference to FIGS. 1-4D, the feature ordering module 102 may determine histograms of values obtained by each of the attributes in clustered data and in non-clustered data.

At block 606, the method may include determining KL distances between the histograms. For example, as described herein with reference to FIGS. 1-4D, the feature ordering module 102 may determine KL distances between the histograms (see also FIG. 3B with respect to KL distances).

At block 608, the method may include ordering the attributes in decreasing order of the KL distances between a respective histogram of the histograms of the clustered data and a respective histogram of the histograms of the non-clustered data. For example, as described herein with reference to FIGS. 1-4D, the feature ordering module 102 may order the attributes in decreasing order of the KL distances between a respective histogram of the histograms of the clustered data and a respective histogram of the histograms of the non-clustered data (see also FIG. 3B with respect to ordering based on KL distances).

At block 610, the method may include generating a plurality of new clusters based on an analysis of the categories of each of the attributes with respect to the order by determining whether a number of samples of the data for a category of the categories meets a specified criterion (e.g., exceeding a specified threshold). For example, as described herein with reference to FIGS. 1-4D, the clustering module 112 may generate a plurality of new clusters 126 based on an analysis of the categories of each of the attributes with respect to the order by determining whether a number of samples of the data for a category of the categories meets a specified criterion (e.g., exceeding the specified threshold 114).

According to an example, for the method 600, generating a plurality of new clusters based on an analysis of the categories of each of the attributes with respect to the order by determining whether a number of samples of the data for a category of the categories exceeds a specified threshold may further include recursively analyzing each of the categories of each of the attributes in increasing order of each of the attributes by determining whether the number of samples of the data for each of the categories of each of the attributes exceeds the specified threshold.

According to an example, the method 600 may further include determining if an attribute of the attributes blocks the determination of sub-clusters of one of the plurality of new clusters, and in response to a determination that the attribute of the attributes blocks the determination of sub-clusters of one of the plurality of new clusters, continue the analysis of other attributes with respect to the one of the plurality of new clusters, and omit the attribute from the ordered attributes with respect to the one of the plurality of new clusters.

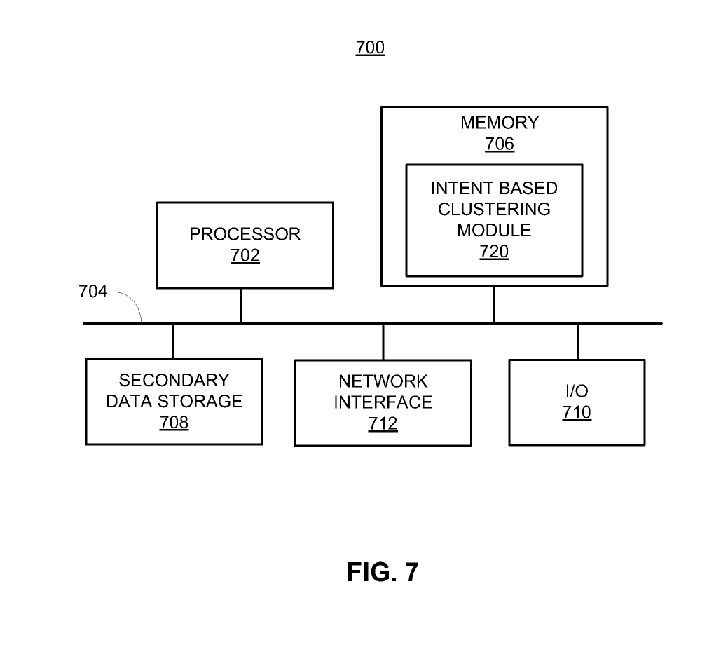

FIG. 7 shows a computer system 700 that may be used with the examples described herein. The computer system 700 may represent a generic platform that includes components that may be in a server or another computer system. The computer system 700 may be used as a platform for the apparatus 100. The computer system 700 may execute, by a processor (e.g., a single or multiple processors) or other hardware processing circuit, the methods, functions and other processes described herein. These methods, functions and other processes may be embodied as machine readable instructions stored on a computer readable medium, which may be non-transitory, such as hardware storage devices (e.g., RAM (random access memory), ROM (read only memory), EPROM (erasable, programmable ROM), EEPROM (electrically erasable, programmable ROM), hard drives, and flash memory).

The computer system 700 may include a processor 702 that may implement or execute machine readable instructions performing some or all of the methods, functions and other processes described herein. Commands and data from the processor 702 may be communicated over a communication bus 704. The computer system may also include a main memory 706, such as a random access memory (RAM), where the machine readable instructions and data for the processor 702 may reside during runtime, and a secondary data storage 708, which may be non-volatile and stores machine readable instructions and data. The memory and data storage are examples of computer readable mediums. The memory 706 may include an intent based clustering module 720 including machine readable instructions residing in the memory 706 during runtime and executed by the processor 702. The intent based clustering module 720 may include the modules of the apparatus 100 shown in FIG. 1.

The computer system 700 may include an I/O device 710, such as a keyboard, a mouse, a display, etc. The computer system may include a network interface 712 for connecting to a network. Other known electronic components may be added or substituted in the computer system.

What has been described and illustrated herein is an example along with some of its variations. The terms, descriptions and figures used herein are set forth by way of illustration only and are not meant as limitations. Many variations are possible within the spirit and scope of the subject matter, which is intended to be defined by the following claims—and their equivalents—in which all terms are meant in their broadest reasonable sense unless otherwise indicated.

What is claimed is:

1. A method for intent based clustering, the method comprising:
assessing data that is to be clustered, wherein the data includes features that include categories;
determining a measure of each of the features;
ordering, by a processor, the features of the data based on the measure of each of the features;
determining whether a number of samples of the data for a category of the categories meets a specified criterion; and
generating a plurality of clusters based on an analysis of the categories of each of the features with respect to the order of each of the features based on the determination of whether the number of samples of the data for the category of the categories meets the specified criterion.

2. The method of claim 1, wherein generating a plurality of clusters based on an analysis of the categories of each of the features with respect to the order of each of the features based on the determination of whether the number of samples of the data for the category of the categories meets the specified criterion further comprises:
recursively analyzing each of the categories of each of the features in order of increasing entropy of each of the features based on the determination of whether the number of samples of the data for each of the categories of each of the features meets the specified criterion of exceeding a threshold.

3. The method of claim 1, wherein the plurality of clusters is designated as initial clusters, the method further comprising:
receiving user feedback related to the initial clusters; and
generating a plurality of new clusters based on the user feedback.

4. The method of claim 3, wherein the user feedback includes changing a definition of at least one of the initial clusters.

5. The method of claim 3, wherein the user feedback includes dividing at least one of the initial clusters.

6. The method of claim 3, wherein generating a plurality of new clusters based on the user feedback further comprises:
ordering the features as a function of histograms of values of each of the features.

7. The method of claim 3, wherein generating a plurality of new clusters based on the user feedback further comprises:
determining histograms of values obtained by each of the features in clustered data and in non-clustered data;
determining Kullback-Leibler (KL) distances between the histograms;
ordering the features based on the KL distances between each of the features; and
generating the plurality of new clusters based on an analysis of the categories of each of the features with respect to the order based on KL distances based on the determination of whether the number of samples of the data for the category of the categories meets the specified criterion.

8. The method of claim 1, further comprising:
processing blocks of the data to generate the plurality of new clusters; and
combining respective new clusters of the plurality of new clusters that are generated based on the processing of the blocks of the data.

9. An intent based clustering apparatus comprising:
a processor; and
a memory storing machine readable instructions that when executed by the processor cause the processor to:
generate a plurality of initial clusters from objects, wherein the objects include features that include categories;
receive user feedback related to the initial clusters;
order the features of the objects as a function of a histogram of values of each of the features based on the user feedback;
determine whether a number of samples of the objects for a category of the categories meets a specified criterion; and
generate a plurality of new clusters based on an analysis of the categories of each of the features with respect to the order based on the determination of whether the number of samples of the objects for the category of the categories meets the specified criterion.

10. The intent based clustering apparatus according to claim 9, wherein the machine readable instructions to generate a plurality of initial clusters from objects further comprise:
ordering the features of the objects based on an entropy of each of the features.

11. The intent based clustering apparatus according to claim 9, wherein the machine readable instructions to generate a plurality of initial clusters from objects further comprise:
recursively analyzing each of the categories of each of the features in order of increasing entropy of each of the features based on the determination of whether the number of samples of the objects for each of the categories of each of the features meets the specified criterion of exceeding a threshold.

12. The intent based clustering apparatus according to claim 9, wherein the machine readable instructions to order the features of the objects as a function of a histogram of values of each of the features based on the user feedback further comprise:
determining histograms of values obtained by each of the features in clustered objects and in non-clustered objects; and
determining Kullback-Leibler (KL) distances between the histograms.

13. A non-transitory computer readable medium having stored thereon machine readable instructions to provide intent based clustering, the machine readable instructions, when executed, cause a processor to:
receive initial clusters, wherein the initial clusters are based on data that includes attributes that include categories;
determine histograms of values obtained by each of the attributes in clustered data and in non-clustered data;
determine Kullback-Leibler (KL) distances between the histograms;
order the attributes in decreasing order of the KL distances between a respective histogram of the histograms of the clustered data and a respective histogram of the histograms of the non-clustered data; and
generate a plurality of new clusters based on an analysis of the categories of each of the attributes with respect to the order by determining whether a number of samples of the data for a category of the categories meets a specified criterion.

14. The non-transitory computer readable medium according to claim 13, further comprising machine readable instructions to:
determine if an attribute of the attributes blocks the determination of sub-clusters of one of the plurality of new clusters; and
in response to a determination that the attribute of the attributes blocks the determination of sub-clusters of one of the plurality of new clusters, continue the analysis of other attributes with respect to the one of the plurality of new clusters, and omit the attribute from the ordered attributes with respect to the one of the plurality of new clusters.

15. The non-transitory computer readable medium according to claim 13, further comprising machine readable instructions to receive user feedback related to at least one of the initial clusters, wherein the user feedback includes at least one of:
a change in a definition of at least one of the initial clusters, and
a division of at least one of the initial clusters.
